(19) United States
(12) Patent Application Publication
(10) Pub. No.: US 2010/0119486 A1
(43) Pub. Date: May 13, 2010

(54) ANTIBACTERIAL TREATMENT METHOD

(75) Inventors: Keiko Sakamoto, Kumamoto (JP); Toshiaki Iwashita, Kumamoto (JP)

Correspondence Address: CHAPMAN AND CUTLER, 111 WEST MONROE STREET, CHICAGO, IL, 60603, US

(73) Assignee: BIG BIO CO., LTD., Kumamoto-shi (JP)

(21) Appl. No.: 12/449,683

(22) PCT Filed: Feb. 19, 2008
(86) PCT No.: PCT/JP2008/052720

§ 371 Date: Nov. 12, 2009

(30) Foreign Application Priority Data
Feb. 21, 2007 (JP) 2007-041525

(51) Int. Cl. A01N 63/00

(52) U.S. Cl. 424/93.3; 424/93.4

(57) ABSTRACT

Disclosed is an antibacterial treatment method which has no limitation in the scope of a material to be treated and which enables to reduce the time or cost required for the antibacterial testament. Specifically disclosed is an antibacterial treatment method using an antibacterial agent comprising a powder produced by mixing a microorganism selected from Bacillus sphaericus, Bacillus subtilis and Bacillus thuringiensis with a cattle feces which is previously treated at a high temperature of 60 to 150° C., wherein the material to be treated and the antibacterial agent are arranged under a non-contacting condition to inhibit the growth of a target bacterium in the material.

### TECHNICAL FIELD

This invention relates to an antibacterial treatment method using an antibacterial agent, and in particular, to an antibacterial treatment method characterized in that antibacterial treatment is carried out using an antibacterial agent in a non-contact state with the object of antibacterial treatment.

### BACKGROUND ART

Various types of antibacterial agents are currently available on the market. As is evident in Patent Document 1, the inventors of the present application found that Bacillus sphaericus, Bacillus subtilis and Bacillus thuringiensis are microorganisms that can be used for mold inhibitors and deodorants, and these microorganisms are easily available from soil, sea water, deposit in fresh water and foods, and can be cultured. In addition, the inventors showed that a powder produced by mixing these microorganisms with cattle feces treated at high temperature can be used to make inexpensive mold inhibitors and deodorants.
Patent Document 1: Japanese Patent No. 3590019

Antibacterial treatment is carried out using conventional antibacterial agents, in accordance with a method for putting the antibacterial agent in contact with the object on which one wishes to carry out antibacterial treatment. As concrete methods for putting the two in contact, methods for incorporating the antibacterial agent in the object and methods for applying or spraying the antibacterial agent are known. However, in these methods for direct contact, the object of antibacterial treatment is limited, and treatment takes time, and thus the cost becomes high.

### DISCLOSURE OF THE INVENTION

### Problem to Be Solved by the Invention

An object of the present invention is to provide an antibacterial treatment method which can solve the above described problems, the object of antibacterial treatment is not limited, and the time and cost for antibacterial treatment can be lessened.

### Means for Solving Problem

The invention according to Claim 1 is an antibacterial treatment method using an antibacterial agent having a powder produced by mixing a microorganism selected from Bacillus sphaericus, Bacillus subtilis and Bacillus thuringiensis with cattle feces treated at a high temperature of 60 degrees to 150 degrees, characterized in that an object for bacterial treatment and the antibacterial agent are in a non-contact state, so that an object bacteria is prevented from growing on the object. Here, the antibacterial treatment method according to the present invention relates not only to antibacterial effects, but also to cases where the antibacterial agent used has sterilizing effects in a non-contact state.

The invention according to Claim 2 is the antibacterial treatment method according to Claim 1, characterized in that the object bacteria includes at least one type of bacteria from among Cladosporium cladosporioides NBRC4459, Cladosporium sphaerospermum NBRC4460, Alternaria alternata NBRC31188, Curvularia lunata NBRC100182 and Thanatephorus cucumeris.

The invention according to Claim 3 is the antibacterial treatment method according to Claim 1 or 2, characterized in that the above described cattle feces are cow feces, pig feces or chicken feces.

The invention according to Claim 4 is the antibacterial treatment method according to any of Claims 1 to 3, characterized in that the antibacterial agent is any of the powder itself, a liquid gained by adding water to the powder, or the liquid absorbed by at least one of a water absorbing gelatinizer, gelatin or agar.

### Effects of the Invention

The microorganism used in the present invention is selected from Bacillus sphaericus, Bacillus subtilis and Bacillus thuringiensis, and thus, the safeness of the microorganism itself has been sufficiently confirmed in the present invention. Thus, the antibacterial agent used in the antibacterial treatment method according to the present invention is utterly harmless at the time of production and use, and has no harmful effects on the environment and the human body. In addition, cattle feces treated at a high temperature of 60 degrees to 150 degrees are used as a source of nutrition for the microorganism, and therefore, raw materials are available at extremely low cost. The present invention makes it possible to use cattle feces effectively and in a highly beneficial way, which is good because treatment of cattle feces has become an environmental issue, in terms of odor and contamination of water sources.

Furthermore, the powder produced by mixing the microorganisms with cattle feces treated at high temperature has antibacterial effects in itself, and in addition, liquids gained by adding water to the powder and water absorbing gelatinizers that absorb water also have antibacterial effects, and therefore, it becomes possible to use the powder in a variety of states. In addition, the antibacterial agent used in the present invention integrally holds microorganisms as a source of nutrition, and therefore, the microorganisms are active for a long period of time, and it is possible to sustain the antibacterial effects for longer.

In particular, it is possible for the antibacterial agent used in the present invention to prevent the object bacteria on the object of antibacterial treatment from growing in a non-contact state with the object. Accordingly, it is not necessary for the antibacterial agent to adhere to the object, and therefore, the object of antibacterial treatment is not limited. In addition, it is not necessary for the antibacterial agent to adhere to the object as a result of application or spraying, and therefore, it is possible to lessen the time and cost for antibacterial treatment.

### BEST MODE FOR CARRYING OUT THE INVENTION

The antibacterial agent used in the antibacterial treatment method according to the present invention is characterized by having a powder produced by mixing a microorganism selected from Bacillus sphaericus, Bacillus subtilis and Bacillus thuringiensis with cattle feces treated at a high temperature of 60 degrees to 150 degrees, a liquid gained by adding water to a powder produced by mixing a microorganism with cattle feces treated at a high temperature of 60 degrees to 150 degrees, or a water absorbing gelatinizer, gelatin or agar that absorbs the liquid.

The microorganism included in the antibacterial agent used in the present invention is selected from Bacillus sphaericus, Bacillus subtilis and Bacillus thuringiensis, and these microorganisms are publicly known and are easy to find in soil, sea water, deposit in fresh water and foods, as well as to culture. In addition, these microorganisms are safe to the environment and the human body, and therefore, it is possible to use antibacterial agents using these as highly safe products.

It is preferable for the cattle feces used in the present invention to be cow feces, pig feces or chicken feces, but it is possible to use various other feces, such as horse feces, if necessary. High temperature treatment is carried out on cattle feces at 60 degrees to 150 degrees for 5 hours in order to remove the large amount of sundry bacteria included therein. Cattle feces treated at high temperature are dry and solid, and solid cattle feces are crushed and converted to a powder, which is then mixed with the microorganism according to the present invention.

According to the present invention, the powder gained by mixing the above described microorganism with cattle feces treated at high temperature has antibacterial effects in itself, and preferably adding water to the powder improves the antibacterial effects.

In addition, according to the present invention, the above described powder can be converted to a liquid, and furthermore, put in a water-absorbing gelatinizer, gelatin or agar, and thus, an antibacterial agent in gel form gained. Thus, it is possible to use the antibacterial agent for the antibacterial treatment method according to the present invention in any form, for example as a powder, a liquid or a gel, and therefore, it is possible to provided an antibacterial agent having an extremely wide range of application.

In particular, the present inventors found as a result of diligent research that the antibacterial agent used in the present invention can prevent the object bacteria from growing on the object for antibacterial treatment in a non-contact state with the object. Thus, an antibacterial treatment method having such excellent effects that it is not necessary for the antibacterial agent to adhere to the object because of the non-contact antibacterial effects and the object for antibacterial treatment is not limited can be implemented. In addition, it is not necessary for the antibacterial agent to adhere to the object as a result of application or spraying, and therefore, it is possible to lessen the time and cost for antibacterial treatment, so that a highly convenient antibacterial treatment method can be provided.

As the object bacteria for which the antibacterial agent of the present invention has non-contact antibacterial effects, Cladosporium cladosporioides NBRC4459, Cladosporium sphaerospermum NBRC4460, Alternaria alternata NBRC31188, Curvularia lunata NBRC100182 and Thanatephorus cucumeris can be cited.

### First Embodiment

Two types of mold inhibitors (trade name: Kabitoreru) having different forms: “BB bacteria (A)” and “BB bacteria (B),” which include BB bacteria (registered trademark) from Big Bio Co., Ltd., were prepared as antibacterial agents. The main properties of the tested antibacterial agent are shown in Table 1. It can be confirmed that these antibacterial agents included Bacillus sphaericus, Bacillus subtilis or Bacillus thuringiensis.

TABLE 1

| | | EC | EC (concentration | External |
|---|---|---|---|---|
| Name of material | pH | (mS/cm) | converted to saline %) | appearance |
| BB bacteria (A) | 7.1 | 11.8 | 0.63 | powder |
| BB bacteria (B) | 7.4 | 5.7 | 0.30 | powder |

In the following tests, the bacteria in Table 1 were used as the object bacteria.

TABLE 2

| Scientific name | Category | General name | Note |
|---|---|---|---|
| (Filamentous fungi) | | | |
| Cladosporium cladosporioides | Fungi imperfecti | black mold | plant pathogen, allergen |
| NBRC 4459 | | | |
| Cladosporium sphaerospermum | | black mold | plant pathogen, allergen |
| NBRC 4460 | | | |
| Alternaria alternata NBRC 31188 | | sooty mold | plant pathogen, allergen |
| Curvularia lunata NBRC 100182 | | | plant pathogen |
| Fusarium oxysporum NBRC 30701 | | | plant pathogen, opportunistic pathogen |
| Thanatephorus cucumeris | Basidiomycetes | damping-off | plant pathogen, mycorhiza bacteria |
| | | pathogen | |
| Saccharomyces cerevisiae | Ascomycota | yeast | baker's yeast, wine yeast |
| (Bacteria) | | | |
| Bacillus cereus | gram-positive | Bacillus cereus | sitotoxic Bacillus |
| | Bacillus | | |
| Staphylococcus aureus 209P-JCI | gram-positive | yellow | sitotoxic Bacillus |
| | Coccus | Staphylococcus | |
| Escherichia coli K12 | gram-negative | Escherichia coli | nonpathogenic strain |
| | Bacillus | | |

(Basic Test)

Tests were conducted using the respective culture media in Table 3. The number of colonies formed by the BB bacteria (A) and (B), and the total number of living bacteria in the respective culture media are shown in Table 4, and the ratio of colonies is shown in Table 5.

TABLE 3

| | |
|---|---|
| Components | g/L |

Nutrient agar (NA)

| | |
|---|---|
| meat extract | 5 |
| peptone | 10 |
| sodium chloride | 5 |
| agar | 15 |
| | pH 7.0 ± 0.1 |

Brain-heart infusion agar culture medium (BHI)

| | |
|---|---|
| cow brain extract powder | 7.5 |
| heart extract powder | 8.0 |
| peptone | 10.0 |
| glucose | 2.0 |
| sodium chloride | 5.0 |
| potassium monohydrogen phosphate | 2.5 |
| agar | 15.0 |
| | pH 7.2 ± 0.1 |

Trypto-Soya agar culture medium (SCD)

| | |
|---|---|
| peptone | 17.0 |
| soy bean peptone | 3.0 |
| sodium chloride | 5.0 |
| glucose | 2.5 |
| potassium monohydrogen phosphate | 2.5 |
| agar | 15.0 |
| | pH 7.3 ± 0.1 |

TABLE 4

| | Total number of | Total number of eutrophic | | |
|---|---|---|---|---|
| | living bacteria | bacteria (cfu/g, dry) | | |
| Name of material | (cells/g, dry) | NA | BHI | SCD |
| BB bacteria (A) | (2.1 ± 0.1) × 10⁹ | (2.8 ± 0.8) × 10⁸ | (2.8 ± 0.9) × 10⁸ | (1.8 ± 0.1) × 10⁸ |
| BB bacteria (B) | (3.2 ± 0.5) × 10⁹ | (2.1 ± 0.3) × 10⁸ | (1.9 ± 0.5) × 10⁸ | (1.4 ± 0.2) × 10⁸ |

TABLE 5

| | Ratio of | | |
|---|---|---|---|
| | colonies (%) | | |
| Name of material | NA | BHI | SCD |
| BB bacteria (A) | 13.3 | 13.3 | 8.6 |
| BB bacteria (B) | 6.6 | 5.9 | 4.4 |

ratio of colonies (%) = (total number of eutrophic bacteria/total number of living bacteria) × 100

(Test for Long-Term Preservation)

As shown in Table 6, the change in the number of bacteria preserved as BB bacteria (A) and (B), which are materials containing microorganisms, was measured. It can be seen from this Fig 1 that there is no change in the number of bacteria after five months in the case where the BB bacteria (A) and (B) are preserved at room temperature in a dry state, and thus, long-term preservation of five months is possible. *¹ in the Table was measured in accordance with an EB fluorescent staining method, *² was measured in accordance with a CFDA fluorescent staining method, and *³ was incubated for 14 days at 30 degrees after smear inoculation in an NA culture medium. In addition, the tested bodies arrived on Jul. 18, 2006 and were preserved at room temperature.

TABLE 6

| | | | Immediately after start of | |
|---|---|---|---|---|
| Sample | Item | Unit | preservation | Five months later |
| BB bacteria | Total number of bacteria *¹ | cells/mg, dry | (1.3 ± 0.2) × 10¹⁰ | (2.0 ± 0.6) × 10¹⁰ |
| (A) | Total number of living bacteria *² | cells/mg, dry | (6.3 ± 1.6) × 10⁹ | (7.1 ± 0.7) × 10⁹ |
| | Ratio of living fungi | % | 48.5 | 35.5 |
| | Total number of eutrophic bacteria *³ | CFU/mg, dry | (3.4 ± 0.5) × 10⁸ | (2.6 ± 0.4) × 10⁸ |
| | Ratio of colonies | % | 5.4 | 3.7 |
| | Water content | % | 23.4 | 20.9 |
| | Date of test | | 24/7/2006 | 23/12/2006 |
| BB bacteria | Total number of bacteria *¹ | cells/mg, dry | (8.7 ± 1.1) × 10⁹ | (9.9 ± 0.9) × 10⁹ |
| (B) | Total number of living bacteria *² | cells/mg, dry | (5.1 ± 0.8) × 10⁹ | (3.1 ± 0.4) × 10⁹ |
| | Ratio of living fungi | % | 58.6 | 31.3 |
| | Total number of eutrophic bacteria *³ | CFU/mg, dry | (3.8 ± 0.4) × 10⁸ | (1.7 ± 0.0) × 10⁸ |
| | Ratio of colonies | % | 7.5 | 5.5 |
| | Water content | % | 16.0 | 18.3 |
| | Date of test | | 24/7/2006 | 23/12/2006 |

(Small-Scale Active Antibacteria Test)

The object bacteria and the antibacterial agent were put in two separate petri dishes, and the two petri dishes were placed on top of each other in a facing position, and thus, the non-contact antibacterial effects were measured in a small space.

The small-scale active antibacteria test was conducted in the following manner:

(1) Preparation of Bacteria Liquid

Bacteria were shake cultured in an L-shaped tube until a late stage of exponential growth, and after that, 200 μL of a fresh culture solution (nutrient broth, 30° C.) of the bacteria was suspended in 1.8 mL of sterilized physiological saline.

In addition, filamentous fungi and yeast were cultured in a potato dextrose agar [PDA] culture medium for one week at 30° C., and after that, the spores were suspended in 0.5 mL of sterilized physiological saline with 0.01% of SDS added.

(2) Smearing

Each culture medium was smear inoculated with 100 μL it of the bacteria suspension liquid in two spots. As for the culture media within the petri dishes, NA culture media were used for the bacteria, and PDA culture media were used for the filamentous fungi and yeast.

(3) Filling/Inoculation

1.5 g of the BB bacteria (A) and (B), which are materials containing microorganisms, was spread over the NA culture medium for each petri dish. Here, in the case where the material was a strain of bacteria, an NA culture medium was inoculated with 0.2 mL after shake culturing until a later stage of exponential growth in the NA culture medium, and incubated for one to two days at 30° C.

(4) Culturing

The two petri dishes prepared in the above (2) and (3) were placed on top of each other with the insides facing (petri dish of above (3) was on bottom), and portions of the petri dishes which made contact were pasted together using surgical tape.

After that, the culture media were incubated at 30° C. The bacteria and yeast were cultured for three days, and the filamentous fungi for seven.

(5) Determination

In the case where growth was clearly suppressed in comparison with the control section, it was determined that there were effects of suppression. Table 7 shows the results of the small-scale active antibacterial test. Cases where growth was suppressed are marked with +, and cases where growth was not suppressed are marked with −.

TABLE 7

| Strain of bacteria | Suppression of growth | |
|---|---|---|
| supplied for test | BB bacteria (A) | BB bacteria (B) |
| Cladosporium cladosporioides | + | + |
| NBRC 4459 | | |
| Cladosporium sphaerospermum | + | + |
| NBRC 4460 | | |
| Alternaria alternata NBRC 31188 | + | + |
| Curvularia lunata NBRC 100182 | + | + |
| Fusarium oxysporum NBRC 30701 | + | + |
| Thanatephorus cucumeris | + | + |
| Saccharomyces cerevisiae | − | − |
| Bacillus cereus | − | − |
| Staphylococcus aureus 209P-JC1 | − | − |
| Escherichia coli K12 | − | − |

It can be seen from Table 7 that the BB bacteria (A) and (B) have non-contact antibacterial effects for Cladosporium cladosporioides NBRC4459, Cladosporium sphaerospermum NBRC4460, Alternaria alternata NBRC31188, Curvularia lunata NBRC100182, Fusarium oxysporium NBRC30701 and Thanatephorus cucumeris, which are object bacteria.

(Medium-Scale Active Antibacterial Test)

Next, object bacteria and the antibacterial agent were put in two separate petri dishes, and the two petri dishes were placed side by side within an airtight container made of plastic with a volume of 1.3 L, and the non-contact antibacterial effects were measured.

The medium-scale active antibacterial test was carried out in the following manner:

(1) Preparation of Bacterial Liquid

The bacteria were shake cultured in an L-shaped tube until a later stage of exponential growth, and after that 200 μL of a fresh culture solution (nutrient broth, 30° C.) of the bacteria was suspended in 1.8 mL of sterilized physiological saline.

In addition, filamentous fungi and yeast were cultured for one week at 30° C. in a potato dextrose agar [PDA] culture medium, and after that the spores were suspended in 0.5 mL of sterilized physiological saline with 0.01% of SDS.

Furthermore, bacteria suspension solutions were prepared for the two, with the concentration adjusted to approximately 1000 cells, or spores/mL. Here, the number of bacteria was measured in accordance with a direct counting method, and the number of spores of filamentous fungi and yeast was measured using a hemacyto meter.

(2) Smearing

Each culture medium was smear inoculated with 100 μL of the bacteria suspension liquid in three spots. As for the culture media within the petri dishes, NA culture media were used for the bacteria, and PDA culture media were used for the filamentous fungi and yeast.

(3) Filling/Inoculation

1.5 g of the BB bacteria (A) and (B), which are materials containing microorganisms, was spread over the NA culture medium for each petri dish.

(4) Culturing

The two petri dishes prepared in the above (2) and (3) were put in a 1.3 L container made of plastic and sealed airtight. After that, the whole was incubated at 30° C. The bacteria and yeast were cultured for three days, and the filamentous fungi for seven.

(5) Determination

The average number of colonies within the petri dishes was measured for the object bacteria, and the value gained by dividing the value gained by subtracting the number of colonies in a test section from the number of colonies in a control section by the number of colonies in the control section is shown in percentage as the degree of growth suppression. Table 8 shows the results of the medium-scale active antibacterial test.

TABLE 8

| | Degree of growth | |
|---|---|---|
| Strain of bacteria | suppression (%) | |
| supplied for test | BB bacteria (A) | BB bacteria (B) |
| Cladosporium cladosporioides | 100 | 100 |
| NBRC 4459 | | |
| Cladosporium sphaerospermum | 100 | 100 |
| NBRC 4460 | | |
| Alternaria alternata NBRC 31188 | 100 | 100 |
| Fusarium oxysporum NBRC 30701 | −2.4* | 7.5* |
| Thanatephorus cucumeris | 100 | 100 |
| Saccharomyces cerevisiae | 8.1* | −6.9* |
| Escherichia coli K12 | −18.5* | 4.2* |
| Staphylococcus aureus 209P-JC1 | −5.7* | 26.1* |

*no significant difference with control section

It can be seen from Table 8 that the BB bacteria (A) and (B) have non-contact antibacterial effects for Cladosporium cladosporioides NBRC4459, Cladosporium sphaerospermum NBRC4460, Alternaria alternata NBRC31188 and Thanatephorus cucumeris, which are object bacteria.

(Large-Scale Active Antibacterial Test)

Next, object bacteria and the antibacterial agent were put in two separate petri dishes, and the two petri dishes were placed side by side within an airtight container made of plastic with a volume of 10 L, and the non-contact antibacterial effects were measured. The large-scale active antibacterial test was the same as the above described medium-scale active bacterial test, except that one petri dish in which an antibacterial agent was put and five petri dishes in which object bacteria were put were put in one plastic container. Here, the object bacteria were only Cladosporium sphaerospermum NBRC4460.

Table 9 shows the degree of growth suppression. Here, a petri dish in which BB bacteria, which are a material containing microorganisms, were put was supplied in a treatment section A for the test, as described above, and the material containing microorganisms was cultured for one week at 30° C. in an NA culture medium before being supplied for the test in a treatment section B.

TABLE 9

| | |
|---|---|
| | Degree of growth |
| Treatment | suppression (%) |

| section | BB bacteria (A) | BB bacteria (B) |
|---|---|---|
| A | 97.8 (92.0) | 84.0 (88.0) |
| B | 90.0 (79.7) | 3.8* (40.8) |

The numbers within parentheses indicate the ratio of growth suppression for colonies.
The ratio of growth suppression for colonies(%) was calculated using the following formula: (1 − average diameter of colonies in treatment section/average diameter of colonies in control section) × 100

It can be seen from Table 9 that the BB bacteria (A) and (B) have non-contact antibacterial effects for Cladosporium sphaerospermum NBRC4460, which are the object bacteria, in a 10 L container. Here, the BB bacteria (b) had no non-contact antibacterial effects in the case where the material containing microorganisms was cultured for one week at 30° C. on an NA culture medium before being supplied for the test.

(Effects of Sterilizing Treatment on Antibacterial Agent)

Change in the non-contact antibacterial effects was measured for a case where sterilizing treatment was carried out on an antibacterial agent. Sterilizing treatment was carried out by putting the BB bacteria (A) and (B) in an autoclave at 120° C. before the test.

The test was conducted in a small space (2 facing petri dishes). In addition, the object bacteria used were Cladosporium sphaerospermum NBRC4460.

Table 10 shows the results of the test.

TABLE 10

Degree of growth
suppression (%)

| | BB bacteria (A) | BB bacteria (B) |
|---|---|---|
| sterilized | 15.3* | 13.9* |
| not sterilized | 100 | 100 |

three spots in test
*no significant difference with control section

It can be seen from Table 10 that there were no non-contact antibacterial effects for the antibacterial agent on which sterilizing treatment was carried out.

(Non-Contact Sterilizing Effects)

Next, the non-contact sterilizing effects were examined.

The test method was as follows:

(1) Preculture of Filamentous Fungi

A strain of filamentous fungi was taken from a master plate and smeared on a PDA slant, and after that cultured for more than a week at 30° C.

(2) Preparation of Spore Liquid

500 μL of physiological saline with 0.01% of SDS added was injected into the bacteria to be tested on the slant, which was then moved into a small test tube using a Pasteur pipette.

(3) Adjustment of Number of Bacteria

The number of spores was measured using a hematite meter, and after that the sample was distilled with physiological saline with 0.01% of SDS added to a concentration a 10³ spores/mL.

(4) Inoculation

A PDA culture medium was inoculated with 100 μL of the adjusted spore liquid.

(5) Incubation

The above described (4) was incubated for one week at 30° C.

(6) Material Treatment

A petri dish with an NA culture medium filled with 1.5 g of a material containing microorganisms (BB bacteria (A) and (B)) and the petri dish in the above (5) were placed on top of each other with the lids removed (with the petri dish in the above (5) on top), and pasted together using surgical tape and incubated for one week at 30° C. In the case of the bacterial liquid, an NA culture medium was inoculated with 200 μL after shake culturing in an NB culture medium until a later stage of exponential growth, and after that, the whole was incubated for one to two days at 30° C.

(7) Inoculation/Incubation

The bacteria to be tested were taken out from the petri dish inoculated with the object bacteria in the above (6) using a platinum loop, and another PDA culture medium was inoculated in ten spots. Then, the whole was incubated for one week at 30° C.

(8) Determination

The number of spots where bacteria grew was measured, and the bactericidal efficiency was found using the following formula:

bactericidal efficiency (%)=(1−number of colonies that grew/10)×100

Table 11 shows the results of the evaluation.

TABLE 11

| Strain of bacteria | Bactericidal efficiency (%) | |
|---|---|---|
| to be tested | BB bacteria (A) | BB bacteria (B) |
| Cladosporium cladosporioides | 100 | 100 |
| NBRC 4459 | | |
| Cladosporium sphaerospermum | 100 | 100 |
| NBRC 4460 | | |
| Alternaria alternata NBRC 31188 | 100 | 100 |
| Curvularia lunata NBRC 100182 | 90 | 100 |

*: bactericidal efficiency (%) = (1 − number of colonies that grew/10) × 100

It can be seen from Table 11 that there were non-contact bactericidal effects for Cladosporium cladosporioides NBRC4459, Cladosporium sphaerospermum NBRC4460, Alternaria alternata NBRC31188 and Curvularia lunata NBRC100182, which are object bacteria. Here, in the case where only agar was used the culture medium for the material containing microorganisms, there were no bactericidal effects even for Cladosporium cladosporioides NBRC4459, which are the object bacteria. Accordingly, the supply of nutrition for the material containing microorganisms, for example the BB bacteria, was determined to be indispensable in order to gain non-contact bactericidal effects, as with antibacterial effects.

### INDUSTRIAL APPLICABILITY

The present invention makes it possible to provide an antibacterial treatment method according to which objects on which antibacterial treatment can be carried out are not limited, and the time and cost for antibacterial treatment can be lessened. In addition, the antibacterial agent of the present invention can be gained using highly safe microorganisms and with low production cost, is utterly harmless at the time of production and use, and thus has no negative effects on the environment and the human body, is sustainable, has non-contact antibacterial and sterilizing effects, and is efficient.

1. An antibacterial treatment method, comprising the step of using an antibacterial agent comprising a powder produced by mixing a microorganism selected from the group consisting of Bacillus sphaericus, Bacillus subtilis and Bacillus thuringiensis with animal feces treated at a high temperature of 60 degrees to 150 degrees, wherein an object of antibacterial treatment and the antibacterial agent are placed in a non-contact state, so that an object bacteria is prevented from growing on the object.

2. The antibacterial treatment method according to claim 1, wherein the object bacteria comprises at least one type of bacteria from the group consisting of Cladosporium cladosporioides NBRC4459, Cladosporium sphaerospermum NBRC4460, Alternaria alternata NBRC31188, Curvularia lunata NBRC100182 and Thanatephorus cucumeris.

3. The antibacterial treatment method according to claim 1, wherein said animal feces are cattle feces, pig feces or chicken feces.

4. The antibacterial treatment method according to claim 1, wherein the antibacterial agent is the powder itself, or is a liquid gained by adding water to the powder.

5. The antibacterial treatment method according to claim 1, wherein the antibacterial agent is a liquid gained by adding water to the powder, said liquid being absorbed by at least one of a water absorbing gelatinizer, gelatin, or agar.

6. The antibacterial treatment method according to claim 2, wherein said animal feces are cattle feces, pig feces or chicken feces.

7. The antibacterial treatment method according to claim 4, wherein said animal feces are cattle feces, pig feces or chicken feces.

8. The antibacterial treatment method according to claim 5, wherein said animal feces are cattle feces, pig feces or chicken feces.

9. The antibacterial treatment method according to claim 2, wherein the antibacterial agent is the powder itself, or is a liquid gained by adding water to the powder.

10. The antibacterial treatment method according to claim 3, wherein the antibacterial agent is the powder itself, or is a liquid gained by adding water to the powder.

11. The antibacterial treatment method according to claim 2, wherein the antibacterial agent is a liquid gained by adding water to the powder, said liquid being absorbed by at least one of a water absorbing gelatinizer, gelatin, or agar.
